(19) United States
(12) Patent Application Publication
(10) Pub. No.: US 2014/0225350 A1
(43) Pub. Date: Aug. 14, 2014

(54) Spring Bar Lift and Attachment System

(71) Applicant: STRAP-TEK LLC, Lebanon, IN (US)

(72) Inventor: David Gramlin, Lebanon, IN (US)

(73) Assignee: Strap-Tek LLC, Lebanon, IN (US)

(21) Appl. No.: 13/872,370

(22) Filed: Apr. 29, 2013

Related U.S. Application Data
(60) Provisional application No. 61/764,742, filed on Feb. 14, 2013.

(51) Int. Cl. B60D 1/24; F16M 13/02

(52) U.S. Cl. CPC B60D 1/247; F16M 13/022
USPC 280/405.1; 248/329; 248/543

(57) ABSTRACT

A spring bar lift and attachment system includes a bracket assembly, a ratchet mechanism, and a flexible strap. The ratchet mechanism is secured to the bracket assembly, and the bracket assembly is configured to be secured to a portion of a frame of a trailer. The flexible strap includes a ratchet end configured to be wound onto the ratchet mechanism and a spring bar end configured to be secured to a spring bar of a weight distribution hitch that is attached to a tow vehicle. The ratchet end of the flexible strap is configured to be wound onto the ratchet mechanism when the bracket assembly is secured to the frame of the trailer and the spring bar end of the flexible strap is secured to the spring bar.

### CROSS-REFERENCE TO RELATED APPLICATIONS

This application claims priority to U.S. Provisional Application Ser. No. 61/764,742 entitled “Spring Bar Lift and Attachment System” by David Gramlin, filed Feb. 14, 2013, the disclosure of which is herein incorporated by reference in its entirety.

### TECHNICAL FIELD

The disclosure is directed to a weight distribution system for a trailer hitch, and in particular, to a spring bar lift bracket assembly for such weight distribution systems.

### BACKGROUND

In standard rear-mounted hitch systems, a hitch bar is mounted to the rear of the tow vehicle and a hitch ball is mounted to the hitch bar. The trailer includes a tongue that extends from the front of the trailer. A coupler is provided on the end of the tongue that is configured to fit securely over the hitch ball and to pivot on the hitch ball as the trailer is being towed. Without a weight distribution system, the tongue weight of the trailer is transferred almost exclusively to the rear axle of the tow vehicle. This can cause the rear end of the tow vehicle to be forced lower to the ground. As the rear end is forced lower, the weight of the tow vehicle is distributed more toward the rear axle. As a result, the weight on the front axle is reduced which can adversely impact the steering, traction, and stopping power of the tow vehicle.

Weight distribution systems are commonly used in trailer hitches to distribute some of the tongue weight of the trailer from the rear axle to the front axle of the tow vehicle. Referring to FIG. 9, weight distribution systems typically comprise a pair of spring bars 2 that are attached to a head assembly 3 on the tow vehicle 4 and that extend under the tongue 5 or the frame of the trailer. To enable weight distribution, the rear of the tow vehicle 4 is lifted with the coupler 6 of the trailer positioned on the hitch ball 7 until the front and rear of the tow vehicle 4 are leveled. As the rear of the tow vehicle is lifted, the spring bars 2 are moved closer to the tongue of the trailer. When a desired degree of leveling has been achieved, the spring bars 2 are connected to the tongue 5 and held in place.

In previously known systems, such as depicted in FIG. 9, the spring bars are connected to the tongue 5 or frame of the trailer by chains 9. As can be seen in FIG. 9, the chains 9 are attached to lift brackets 8 that are mounted onto the tongue 5 of the trailer. The lift brackets 8 and chains 9 serve to hold the spring bars 2 in tension a fixed distance from the tongue of the trailer. For this type of system, a vehicle jack (not shown) must be used to raise the rear end of the tow vehicle 4 to allow the chain to be hooked onto the lift bracket. The jack is then lowered to see if a desired amount of tension in the spring bars 2 has been achieved. If not, the tow vehicle must be jacked up again so the chain length can be adjusted and then lowered again to check the tension in the spring bars. This process may have to be repeated numerous times until the correct tension is achieved.

In addition, the lift brackets of previously known systems typically have a rock-over or snap-up type design for securing the chain to the bracket and applying a final tension to the spring bars. The rock-over and snap-up type designs require the use of a lever to turn a latch mechanism over against the load on the spring bars which can require a significant amount of leverage and which, in some cases, can result in the lever being snapped back into the operator and/or flung some distance away.

### DRAWINGS

FIG. 1 depicts a front view of an embodiment of a spring bar lift and attachment assembly for a weight distribution system.

FIG. 2 is a perspective view of a weight distribution system including the an embodiment of the spring bar lift and attachment assembly of FIG. 1.

FIG. 3 is a top view of the spring bar lift and attachment assembly of FIG. 1.

FIG. 4 is a side view of the spring bar lift and attachment assembly of FIG. 1.

FIG. 5 is a perspective view of the spring bar lift and attachment assembly of FIG. 1 showing the locking mechanism.

FIG. 6 is an elevational view of the strap of the spring bar lift and attachment assembly of FIG. 1.

FIG. 7 is a schematic diagram of the spring bar lift and attachment assembly of FIG. 1 with the ratchet mechanism arranged at an angle with respect to the bracket assembly.

FIG. 8 is a schematic view of the spring bar lift and attachment assembly of FIG. 7 showing the slot and bolt that enable angular adjustment of the ratchet mechanism.

FIG. 9 is a depiction of a weight distribution system according to the prior art.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles of the disclosure as would normally occur to one of ordinary skill in the art to which this disclosure pertains.

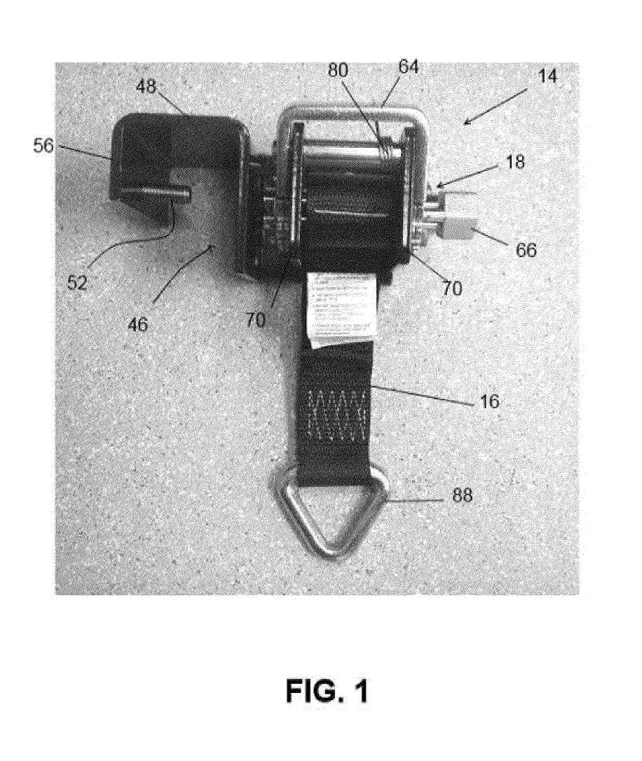

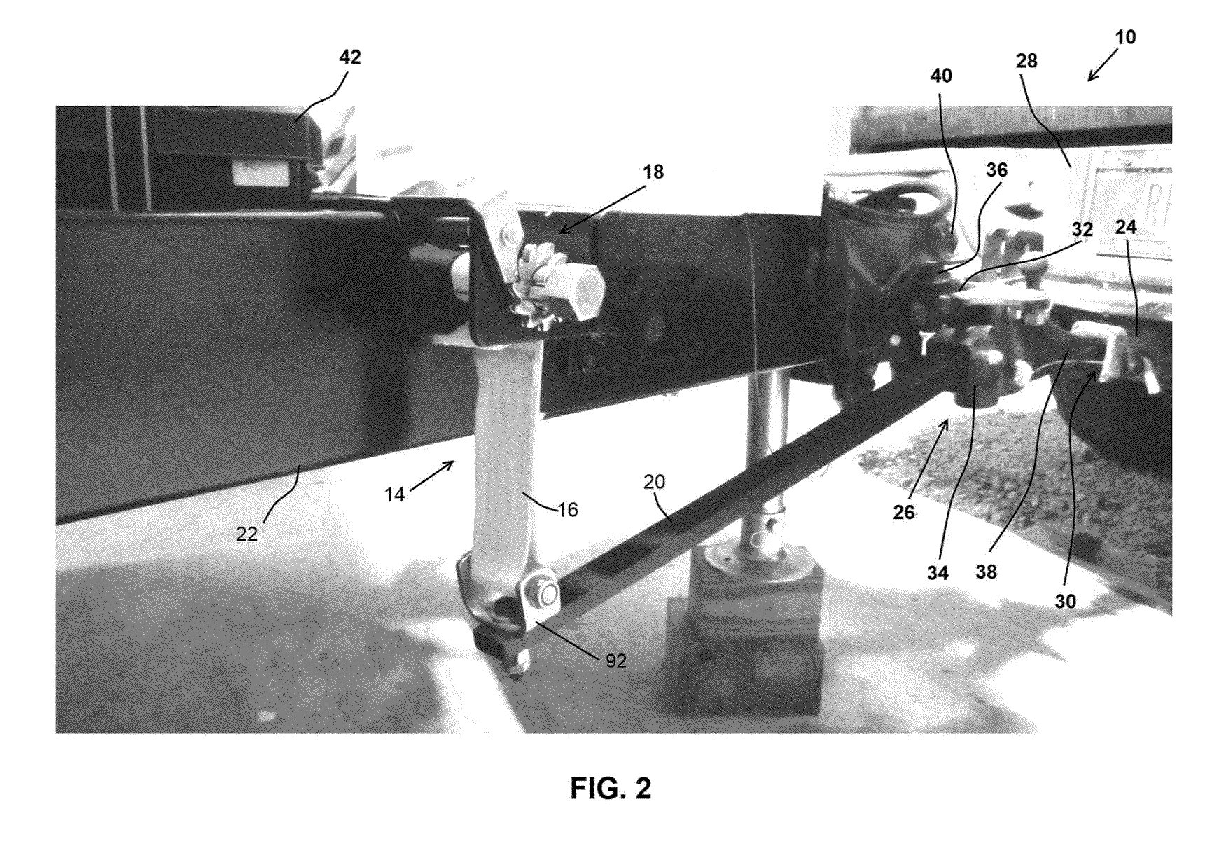

Referring to FIG. 1, an embodiment of a spring bar lift and attachment assembly 14 for use with a weight distribution system 10 (FIG. 2) is depicted. As explained below, the spring bar lift and attachment assembly 14 replaces the snap-up lift bracket and lift chains typically used in the prior art. The spring bar lift and attachment assembly 14 utilizes ratchet straps 16 and ratchet mechanisms 18. The ratchet straps 16 are formed of flexible webbing material, such as polyester, that attach to the spring bars 20 (FIG. 2). The ratchet mechanisms 18 are used to wind the straps 16 in order to lift the spring bars 20 and hold the spring bars a fixed distance from the frame 22 of the trailer.

The spring bar lift and attachment assembly 14 has advantages over previously known lift brackets that utilize chains and snap-up or rock-over type lift brackets. For example, the strap 16 of the spring bar lift and attachment assembly 14 can be arbitrarily long which enables the spring bars 20 to be lifted from the ground without requiring a jack to lift the rear end of the tow vehicle. In addition, the ratchet mechanisms 18 can be operated by a wrench and rotated in smaller increments so the operator is not faced with significant leverage requirements and the dangers of snap back associated with the rock-over and snap-up type bracket designs. These and other benefits of the spring bar lift and attachment assembly 14 will be explained in more detail below.

Referring to FIG. 2, the weight distribution system 10 includes a trailer hitch 24 and a head assembly 26. The trailer hitch 24 comprises a support structure that is secured to the frame of the tow vehicle 28. The trailer hitch 24 can be provided in a variety of different configurations and designs depending on the type of tow vehicle and desired weight-carrying capabilities. The trailer hitch 24 may include a receiver opening 30. The receiver opening 30 is configured to accommodate various inserts, such as a shank or a bicycle rack.

The head assembly 26 for the weight distribution system 10 is attached to the trailer hitch 24 and includes a hitch ball platform 32 and spring bar attachment structures 34. A hitch ball 36 is mounted to the hitch ball platform 32. The hitch ball 36 can be provided in a variety of sizes and shapes for different applications and may be removably mounted to the hitch ball platform 32 so that different hitch balls can be installed on the head assembly 26 as needed. The head assembly 26 is attached to the hitch by a shank 38 that is configured to slide into the receiver opening 30 of the hitch 24. The shank 38 can be provided in a variety of configurations with different lengths, drops, and rises in order to position the head assembly 26 and hitch ball 36 at a desired position relative to the tow vehicle 28 and the coupler 40 of the trailer 42.

The spring bars 20 are attached to the spring bar attachment features 34 of the head assembly 26. The spring bars are typically made of a metal material with some limited flexibility, such as spring steel, that is capable of flexing and returning to shape. Spring bars 20 can be provided in a variety of different sizes, shapes, and flexibilities for different applications and system configurations.

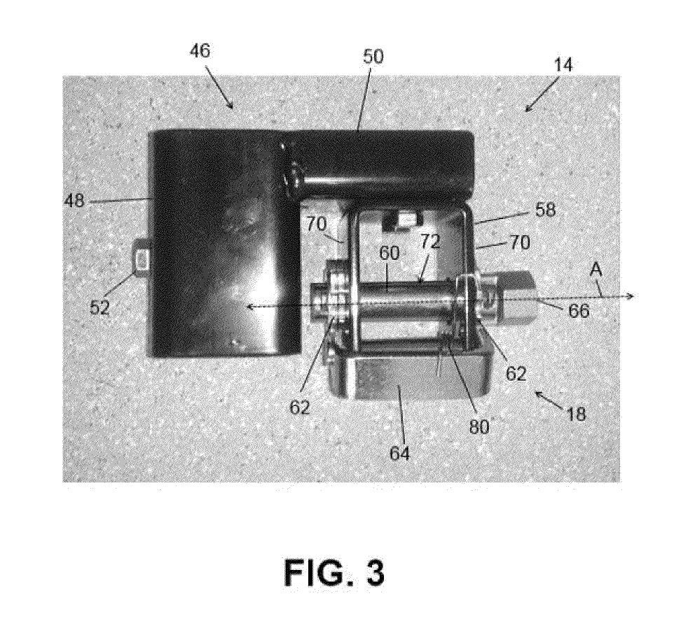

A spring bar lift and attachment assembly 14 in accordance with the present disclosure is used to connect each spring bar 20 to the frame 22 of the trailer 42 and hold the spring bars at a desired distance from the frame 22. The spring bar lift and attachment assembly 14 includes a bracket assembly 46 for supporting the ratchet mechanism 18 and ratchet strap 16. Referring to FIGS. 1 and 3, the bracket assembly 46 comprises a mounting bracket 48 and a ratchet support member 50.

The mounting bracket 48 is formed of metal material, such as ¼ inch steel plate, formed into a saddle bracket configuration that is configured to fit over the cross-sectional shape of the frame 22 (FIG. 2) of the trailer 42. In this embodiment, the mounting bracket 46 is secured to the frame 22 by a friction bolt 52 that is threaded through an opening provided in the lip portion 56 of the bracket 48 until it presses against the frame 22. The contact between the friction bolt 52 and the frame 22 generates friction that helps hold the mounting bracket 48 in position on the frame 22. In alternative embodiments, the mounting bracket 48 may be provided in a variety of other configurations for removably attaching to the frame 22 of the trailer. For example, the mounting bracket 48 may be configured as a double bar clamp (not shown) that is bolted onto the frame 22.

The ratchet support member 50 is attached to the mounting bracket 48 and provides a mounting position for the ratchet mechanism 18 that locates the ratchet mechanism 18 at a desired position and orientation with respect to the trailer frame 22 and spring bars 20. As depicted in FIGS. 1 and 3, the support member 50 comprises a bent steel plate that is welded onto the mounting bracket 48 at one end and that extends from the mounting bracket 48 at substantially a right angle. In alternative embodiments, the support member 50 may be provided as an integral structure with the mounting bracket 48. For example, the mounting bracket 48 and support member 50 may be formed integrally as a cast metal part.

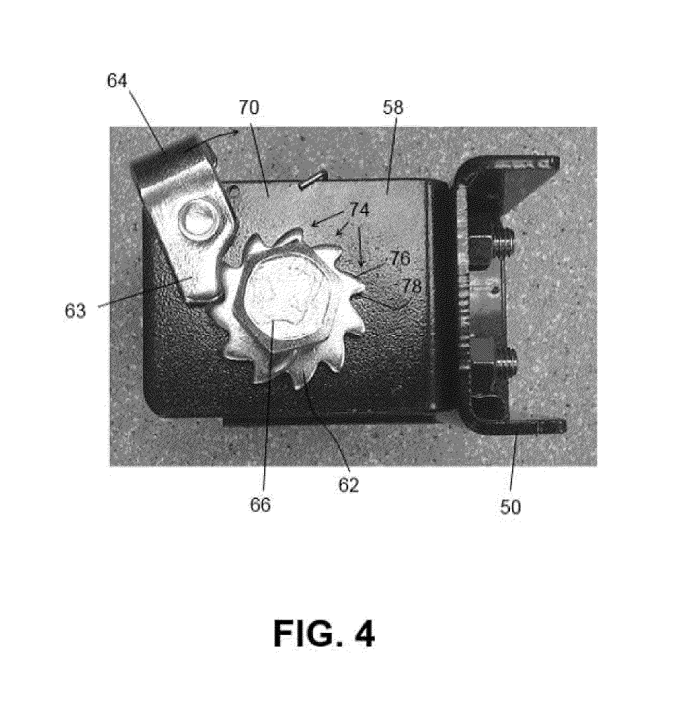

Referring now to FIGS. 1, 3, and 4, the ratchet mechanism 18 is mounted to the support member 50 and includes a ratchet frame 58, a mandrel 60, ratchet wheels 62, ratchet pawls 63, a release handle 64, and a drive member 66. The ratchet frame 58 comprises a metal structure having a generally u-shaped configuration that is attached to the ratchet support member 50 with a pair of spaced apart sidewalls 70 that extend outwardly from the base portion 68 at substantially a right angle with respect to the support member 50. The sidewalls 70 are spaced apart a distance that is sufficient to accommodate the width of the strap 16. As depicted in FIG. 4, the ratchet frame 58 is bolted onto the support member 50. In alternative embodiments, the ratchet frame 58 may be attached to the support member 50 in any suitable manner, such as by welding, or as an integral structure with support member 50 and mounting bracket 48. For example, ratchet frame 58, support member 50, and mounting bracket 48 may be formed integrally as a cast metal part.

The mandrel 60 extends through each sidewall 70 and is supported for rotation about an axis A. The mandrel 60 includes a longitudinal slot 72 (FIG. 3) that extends through the mandrel 60 for receiving an end of the strap 16 so that strap 16 can be wound onto the mandrel 60. A ratchet wheel 62 is attached to each end of the mandrel 60 adjacent the outer surfaces of the sidewalls 70. The ratchet wheels 62 are configured to rotate with the mandrel 60 about the axis A.

Referring to FIG. 4, the ratchet wheels 62 are configured to interact with ratchet pawls 63 that are pivotably mounted to the ratchet frame 58. As can be seen in FIG. 4, each ratchet wheel 62 includes cam structures 74 having a ramp surface 76 and a blocking surface 78. Each ratchet pawl 63 is configured to engage the blocking surface 78 of the cam structures 74 to prevent rotation of the ratchet wheels 62 in a first direction. The ramp surface 76 of the cam structures 74 is configured to allow rotation of the ratchet wheels 62 by engaging an inner side of the ratchet pawls 63 and moving the ratchet pawls out of the way so the ratchet wheels 62 and mandrel 60 can be rotated in a second direction opposite the first direction.

The drive member 66 is attached to the outer end of the mandrel 60. The drive member 66 has a keyed shape for cooperating with a complementarily keyed tool driver or wrench so the mandrel 60 can be driven to rotate in order to wind or unwind the strap 16. In the embodiment of FIGS. 1-4, the drive member 66 has a hex head shape for cooperating with a hex head wrench. The hex head drive 66 is provided in a standard size, e.g., 1⅛″, so that a standard sized wrench or socket may be used to turn the hex head drive member. Of course, other suitable sizes for the hex head drive may be used. In alternative embodiments, the drive member may be provided in other shapes and configurations that enable a driver tool to rotate the ratchet mechanism.

In the embodiment of FIGS. 1-4, the ratchet pawls 63 form parts of a release handle 64 that is pivotably attached to the ratchet frame 58. The release handle 64 is pivotable between an engaged position (e.g., FIG. 3) where the ratchet pawls 63 are positioned in engagement with the ratchet wheels 62 and a released position (not shown) where the ratchet pawls 63 are spaced apart from the ratchet wheels 62. A biasing member 80 (FIG. 3), such as a coil spring, is used to bias the release handle 64 and the ratchet pawls 63 toward the engaged position. When in the released position, the ratchet wheels 62 are capable of being rotated in the first direction which facilitates the installation and removal of the strap 16 from the mandrel 60. In alternative embodiments, the ratchet pawls 63 and release handle 64 may be provided as separate mechanisms that interact to provide the ratchet release functionality.

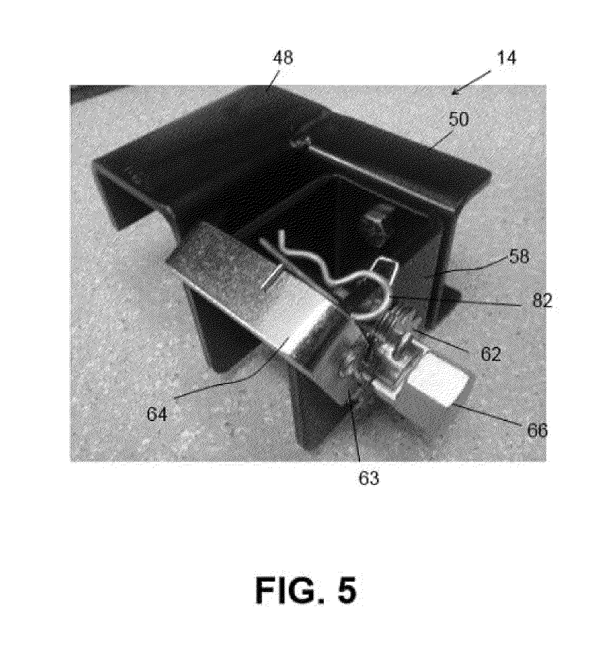

Referring to FIG. 5, a locking mechanism 82 is used to lock the release handle 64 and ratchet pawls 63 in the engaged position and to prevent the release handle 64 and ratchet pawls 63 from inadvertently being moved to the released position. In the embodiment of FIG. 5, the locking mechanism 82 comprises a cotter pin that is inserted through the ratchet frame 58 next to the release handle 64 to block movement of the release handle from the engaged position. The pin 82 is removed from the ratchet frame 58 to allow the release handle 64 to be moved from the engaged position. In other embodiments, the locking functionality may be implemented in other ways and with other mechanisms. For example, in one embodiment, the locking mechanism may comprise an arm structure (not shown) that sits on top of the ratchet frame 58 and ratchet mechanism 18 in a position to block movement of the release handle 64 toward the released position. The arm structure can be moved, e.g., by pivoting, to allow the release handle 64 to be moved toward the released position.

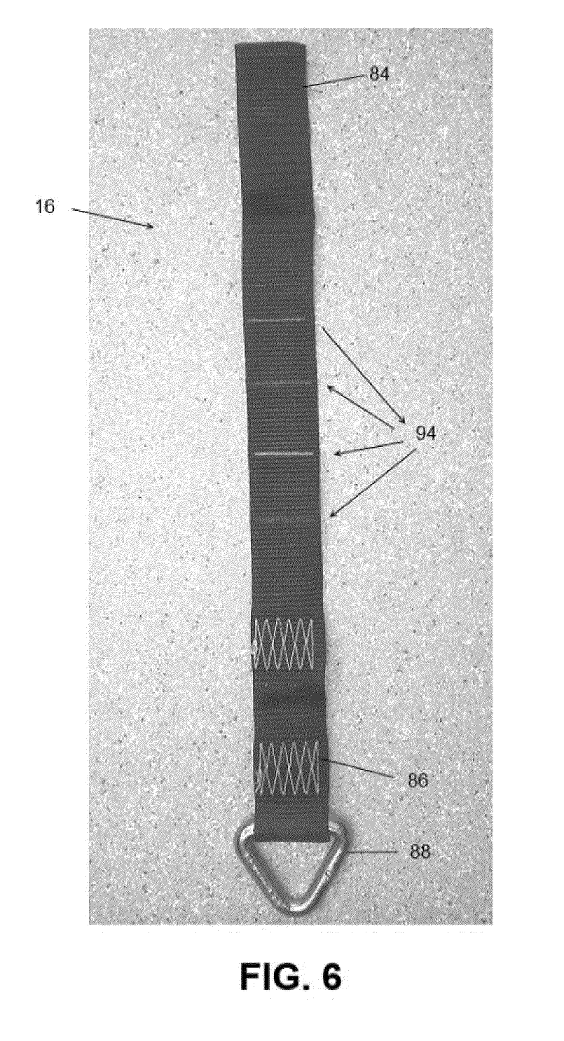

Referring to FIG. 1, the ratchet strap 16 is formed of a strong, flexible material that is capable of holding the spring bars in sufficient tension without breaking or stretching significantly and that is resistant to tearing. The spring bars 20 are typically placed in approximately 650 lbs. of tension by a weight distribution system when the system is installed. Therefore, the strap 16 must have a working load limit that is capable of safely and reliably handling at least 650 lbs. In the embodiment of FIGS. 1 and 6, the ratchet strap 16 is formed of a polyester webbing material with a width of approximately 2 inches and has a break strength rating of 12,000 lbs. and a working load limit of 3,335 lbs.

Referring to FIGS. 1 and 6, the strap 16 includes a ratchet end 84 and a spring bar end 86. The strap 16 is wound onto the ratchet mechanism 18 by inserting the ratchet end of the strap 16 through the slot 72 (FIG. 3) in the mandrel 60. The mandrel 60 is then rotated to wind the strap 16 onto the mandrel 60. The spring bar end 86 of the strap 16 includes an attachment member 88 for removably attaching the spring bar end 86 of the strap 16 to a complementary attachment feature 90 provided on each spring bar 20. In the embodiment of FIGS. 1 and 6, the attachment member 88 comprises a metal ring, such as a D-ring or similar type structure, that is secured to the spring bar end 86 of the strap 16, e.g., by extending the strap 16 through the ring 88 and sewing the end of the strap 16 to form a loop.

In the embodiment of FIG. 6, the metal ring 88 on the end of the strap 16 is linked to a U-bolt (not shown) provided on the spring bar 20. U-bolts are a standard feature found on spring bars of previously known weight distribution systems for attaching chains to the spring bars. Therefore, the spring bar lift and attachment assembly disclosed herein can be provided as a replacement kit for the lift bracket and chains of previously known systems without requiring a modification of the spring bars to attach the straps. Of course, in alternative embodiments, the straps 16 may be attached to the spring bars 20 in other ways. For example, FIG. 2 depicts an embodiment of a strap attachment member that comprises a U-shaped plate 92 attached to the end of the strap 16 that is bolted onto the spring bar 20.

In use, a spring bar lift and attachment assembly 14 is mounted to the frame 22 over each spring bar 20. The ends 86 of the straps 16 are then secured to the spring bars 20. Because the spring bar lift and attachment assembly 14 utilizes a ratchet strap rather than a chain, the rear end of the tow vehicle does not have to be lifted to bring the spring bars 20 up closer to the frame 22 so the chains can be attached to the lift brackets. Rather, the straps 16 can be provided at lengths that are sufficient to reach from the frame 22 to the ground so the straps 16 can be fastened to the spring bars 20 without having to jack up the tow vehicle. In one embodiment, the straps 16 have a length of approximately 2 feet although any suitable length may be used.

Once the straps 16 are fastened to the spring bars 20, the ratchet mechanisms 18 are rotated to wind the straps 16 and pull the spring bars upwardly toward the frame until a desired amount of vehicle leveling and tensioning of the spring bars 20 have been achieved. The ratchet mechanisms 18 can be operated by turning the drive member 66 with a suitable tool driver or wrench. This provides a safe and controlled method of lifting and attaching the spring bars to the trailer while reducing the effort required and the risk of snap back relative to most previously known weight distribution systems. The strength rating of the strap enables the spring bars to be pulled up close to the frame of the trailer which helps reduce sway.

The tension in the spring bars 20 can be easily adjusted by simply winding or unwinding the straps 16 without requiring the use of a jack to raise and lower the rear end of the tow vehicle and tongue of the trailer. The straps 16 can be provided with marking features 94 to facilitate adjustments and consistent distances. For example, each strap 16 can be provided with the same markings that identify certain distances so that each strap 16 can be wound onto the corresponding ratchet mechanism the same distance. In the embodiment of FIG. 6, the markings 94 comprise color coded stripes that can be applied to the strap or printed onto the strap as ink or paint. Alternatively, color coded stripes can be provided as strips of thread sewn into the strap. The markings may be provided in various increments or distances with respect to each other. Any suitable type of marking may be provided that facilitates the installation, alignment, and adjustments of the straps 16 and spring bars 20.

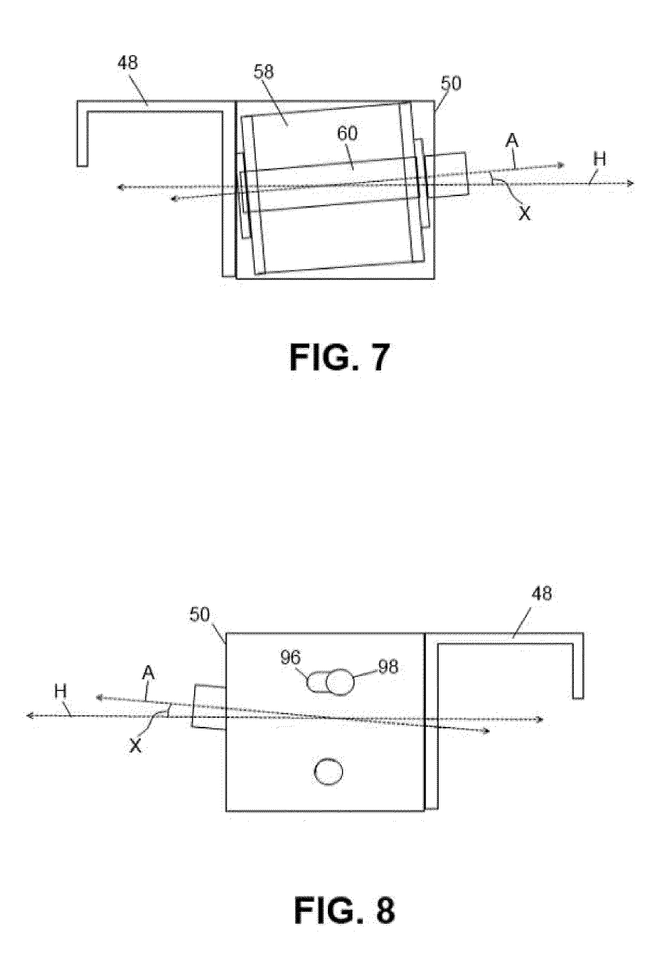

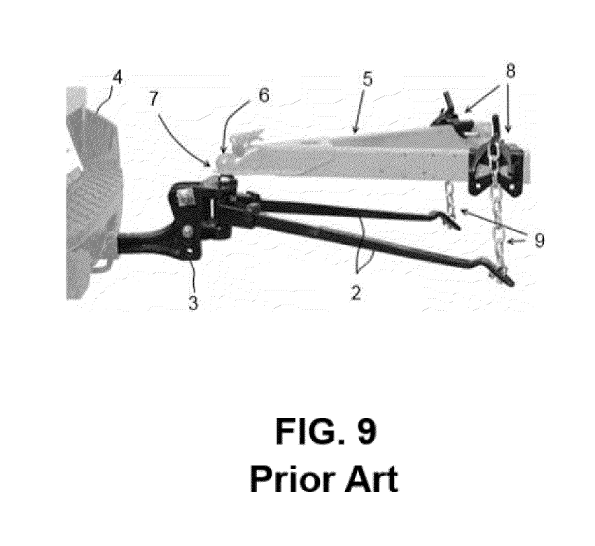

As the straps 16 are wound onto the ratchet mechanisms 18, the spring bars 20 are pulled upwardly toward the frame 22. In some cases, the spring bars 20 are angled outwardly farther than the frame 22 which results in the spring bars 20 being pulled inwardly toward each other as they are pulled upwardly. This added tension can be beneficial in helping to reduce sway. When the spring bars are angled outwardly in this manner, winding of the strap 16 onto the ratchet mechanism can be further facilitated by arranging the ratchet mechanisms 18 so that the axis A of the mandrel 60 is angled slightly with respect to horizontal. For example, the ratchet mechanism can be mounted to the support member such that outer portion of the mandrel is slightly elevated relative to the inner portion of the mandrel. The ratchet mechanism 18 can be positioned at any suitable angle relative to horizontal. In one embodiment, the ratchet mechanism 18 is provided at an angle X of approximately 3° with respect to horizontal H as depicted in FIG. 7.

In one embodiment, the ratchet mechanism 18 is adjustably mounted to the support member 50 to enable the angle of the ratchet mechanism 18 to be adjusted to accommodate the spread of the spring bars 20. As an example, referring to FIG. 8, the support member 50 may include a slot 96 for receiving a fastener 98, such as a bolt, that is used to secure the ratchet frame 58 of the ratchet mechanism 18 to the support member 50. When the bolt 98 is loosened, the slot 96 is sized to allow the bolt 98 to move laterally within the slot to a certain degree to enable the angle of the ratchet frame 58 and ratchet mechanism 18 to be adjusted. When the ratchet mechanism 18 is positioned at the desired angle, the bolt 18 can be tightened to secure the ratchet frame 58 and ratchet mechanism 18 in this position.

In the embodiments depicted in FIGS. 1-8, the ratchet mechanism 18 is supported with the axis A of the mandrel 60 arranged substantially perpendicular to a longitudinal dimension of the frame 22 and the spring bar 20. This configuration facilitates the attachment of the strap 16 to a U-bolt 90 that is typically provided on the spring bar 20. In alternative embodiments, the ratchet mechanism 18 may be supported at other orientations. For example, the ratchet mechanism 18 may be supported with the axis A of the mandrel 60 oriented substantially parallel to the frame 22 and the spring bar 20 (not shown).

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. A spring bar lift and attachment system comprising:
a bracket assembly configured to be secured to a portion of a frame of a trailer;
a ratchet mechanism secured to the bracket assembly; and
a flexible strap including a ratchet end and a spring bar end, the ratchet end being configured to be wound onto the ratchet mechanism, the spring bar end being configured to be secured to a spring bar of a weight distribution hitch that is attached to a tow vehicle; and
wherein the ratchet end of the flexible strap is configured to be wound onto the ratchet mechanism when the bracket assembly is secured to the frame of the trailer and the spring bar end of the flexible strap is secured to the spring bar until the spring bar is moved from a first position below the frame of the trailer to a second position below the frame of the trailer, the second position being closer to the frame than the first position.

2. The system of claim 1, wherein the strap is formed of a polyester webbing material.

3. The system of claim 1, wherein the ratchet mechanism includes a drive member configured to cooperate with a tool driver to turn the ratchet mechanism.

4. The system of claim 1, wherein the bracket assembly is configured to support the ratchet mechanism with an axis of the ratchet mechanism perpendicular to the spring bar.

5. The system of claim 1, wherein the strap includes markings for indicating predetermined lengths or distances.

6. The system of claim 1, wherein the ratchet mechanism includes a ratchet wheel attached to a mandrel and a ratchet pawl, the ratchet pawl being coupled to a release handle that is configured to move between an engaged position in which the ratchet pawl is positioned in engagement with the ratchet wheel and rotation of the mandrel is allowed in only a single direction and a released position in which the ratchet pawl is spaced apart from the ratchet wheel and rotation of the mandrel is allowed in two directions.

7. The system of claim 6, wherein the ratchet mechanism includes a locking mechanism for releasably locking the release handle in the engaged position.

8. The system of claim 1, wherein the ratchet mechanism is adjustably mounted to the bracket assembly in a manner that enables the ratchet mechanism to be adjusted to position the axis of the ratchet mechanism at different angles with respect to horizontal.

9. A method of operating a spring bar lift and attachment system of a weight distribution system, the method comprising:
attaching a ratchet end of a first flexible strap to a first ratchet mechanism that is secured to a front portion of a frame of a trailer to be towed;
attaching a spring bar end of the first flexible strap to a first spring bar of a weight distribution hitch that is attached to a tow vehicle for towing the trailer, the first spring bar extending from the hitch toward the trailer and being positioned a first distance below the front portion of the frame; and
winding the ratchet end of the first flexible strap onto the first ratchet mechanism until the spring bar end of the first flexible strap pulls the first spring bar upwardly toward the frame of the trailer to a position that is a second distance below the front portion of the frame, the second distance being less than the first distance.

10. The method of claim 9, wherein the flexible strap is formed of a polyester webbing material.

11. The method of claim 9, wherein the ratchet mechanism includes a drive member configured to cooperate with a tool driver to turn the ratchet mechanism; and
wherein winding the ratchet end of the first flexible strap further comprises rotating the drive member of the ratchet mechanism with a tool driver until the spring bar is moved to the first position.

13. The method of claim 9, wherein the first ratchet mechanism includes a bracket assembly that removably secures the first ratchet mechanism to the frame of the trailer.

14. The method of claim 13, wherein the first ratchet mechanism defines an axis about which the first flexible strap is wound onto the first ratchet mechanism, and
wherein the first ratchet mechanism is supported by the bracket assembly with the axis arranged generally horizontally and perpendicularly with respect to a longitudinal dimension of the frame and the first spring bar.

15. The method of claim 14, wherein the first ratchet mechanism is adjustably secured to the bracket assembly in a manner that enables the ratchet mechanism to be positioned with the axis at a non-zero angle with respect to horizontal.

16. The method of claim 15, further comprising:
prior to winding the flexible strap onto the first ratchet mechanism, adjusting the first ratchet mechanism such that the axis is moved from substantially horizontal to a first angle with respect to horizontal.

17. The method of claim 16, wherein the first angle is approximately 3°.

18. The method of claim 9, wherein the first flexible strap has a length that enables the first flexible strap to be attached to the first ratchet mechanism and the spring bar end of the strap to be attached to the first spring bar without having to raise a rear end portion of the tow vehicle or the front portion of the frame of the trailer.

19. The method of claim 18, further comprising:
attaching a ratchet end of a second flexible strap to a second ratchet mechanism that is secured to the front portion of the frame of the trailer to be towed;
attaching a spring bar end of the second flexible strap to a second spring bar of the weight distribution hitch, the second spring bar extending from the hitch toward the trailer and being positioned a third distance below the front portion of the frame; and
winding the ratchet end of the second flexible strap onto the second ratchet mechanism until the spring bar end of the second flexible strap pulls the second spring bar upwardly toward the frame of the trailer to a position that is a fourth distance below the front portion of the frame, the fourth distance being less than the third distance.

20. The method of claim 18, wherein the first flexible strap and the second flexible strap include identically positioned markings for indicating predetermined distances and/or lengths such that the second distance and the fourth distance are approximately the same.
